(19) United States
(12) Patent Application Publication
(10) Pub. No.: US 2017/0367533 A1
(43) Pub. Date: Dec. 28, 2017

(54) Canted Grill

(71) Applicant: SCS Direct Inc., Trumbull, CT (US)

(72) Inventor: Benjamin Ebersold, Trumbull, CT (US)

(21) Appl. No.: 15/617,022

(22) Filed: Jun. 8, 2017

Related U.S. Application Data
(60) Provisional application No. 62/353,605, filed on Jun. 23, 2016.

(51) Int. Cl. A47J 37/07

(52) U.S. Cl. CPC A47J 37/0763

(57) ABSTRACT

A canted grill has a lid, a base, a cooking grate and four telescoping legs. The lid and the base fit together to form a cooking chamber with a rectangular box shape. The cooking grate is mounted inside the cooking chamber at an acute angle with respect to a side face of the cooking chamber. This gives the cooking chamber a canted look when the telescoping legs are adjusted so that the grate is horizontal. The canted cooking chamber has a deep side and a shallow side. Charcoal is placed in a firebox in the deep side. This provides direct heat to food placed on the cooking grate above it. Food placed on the cooking grate on the shallow side is heated indirectly by the charcoal. When not in use, the telescoping legs are collapsed and rotated so that they fit beside the cooking chamber.

### FIELD OF INVENTION

The inventions described herein are in the field of portable barbecue grills.

### BACKGROUND

FIG. 1A is a perspective view of a prior art portable charcoal grill 100. The grill comprises a lid 102 and a base 104. A lip 106 is provided on the bottom edge of the lid. When the grill is closed, the lip rests on the top edge of the base and forms an air seal. The air seal is not necessarily air tight but may have a small amount of air flow therethrough. The combined lid and base are referred to herein as a cooking chamber. The cooking chamber comprises a front face 112, a back face 114, a left face 116, a right face 118, a top face 122, and a bottom face 124. Each face is generally planar and has a generally rectangular shape with rounded corners. Faces on opposite sides of the cooking chamber are generally parallel. Adjacent faces are generally at right angles to each other. The lip generally bisects the left, right, front and back face. The plane of the lip is at a right angle 126 with respect to the right face. Thus the plane of the lip is generally parallel to the top and bottom face.

One or more legs 136 are provided to stand the grill off of the surface it is resting on. One or more vents 132 are provided in the top of the lid to let smoke and other combustion products leave the grill. A handle 134 is provided to lift the lid off of the base.

FIG. 1B is a perspective view of the base 104 with the lid removed. A cooking grate 142 is provided at about the top edge of the base. A charcoal grate 144 is provided below the cooking grate, but above the bottom of the base. When in use, the cooking grate is removed, and charcoal is placed on the charcoal grate and lit. The cooking grate is then replaced on the base and food is cooked. Alternatively, the charcoal may be lit before being placed on the charcoal grate.

One of the limitations of the prior art design is that it is difficult to isolate the charcoal to one side of the grill so that one portion of the cooking grate can be used for high temperature searing of meat and another portion can be used for lower temperature roasting. Another limitation of the prior art design is that the area of the cooking grate is limited to the area of the bottom face since they are parallel and since the cooking chamber has a generally rectangular box shape.

### SUMMARY OF INVENTION

The summary of the invention is a guide to understanding the invention. It does not necessarily describe the most generic embodiment.

FIG. 2 is a front left perspective view of a four wheel canted grill 200 in a usage configuration. The canted grill provides for a high temperature searing cooking zone and a lower temperature roasting zone in the same cooking grate. It also increases the cooking grate area relative to the area of the bottom face of the cooking chamber.

The canted grill comprises a lid 202 and a base 204. The lid fits on said base to form a cooking chamber 201. The cooking chamber has a generally rectangular box shape. It comprises a front face 212, back face 214, top face 216, bottom face 218, left face 222 and right face 224. Each face has a generally rectangular shape with rounded corners. Opposite faces are generally parallel. Adjacent faces are generally at about right angles (i.e. 90 degrees) to each other. The lid comprises a lip 206 about its bottom edge. The lip rests on the upper edge 203 of the base when the lid is closed. The lid may be attached to the base by one or more lid hinges (item 402, FIG. 4). The hinge(s) join the bottom edge of the back of the lid to the top edge of the back of the base.

The plane of the lip forms an acute angle 226 with respect to the right face of the cooking chamber. Thus the assembled lid and base have a canted appearance with a deep side 232 and a shallow side 234 when the plane of the lip is in a generally horizontal orientation. A planar cooking grate 404 (FIG. 4) may be provided inside the cooking chamber at about the level of the lip. Thus the cooking grate also forms said acute angle 226 (FIG. 4) with respect to said right face. If the lip is nonplanar, then said base has a deep side and shallow side when the cooking grate is about horizontal.

The corners of the front face form a top vertex 252, a bottom vertex 254, a right vertex 256 and a left vertex 258. The lip is shown proceeding from the left vertex to the right vertex. The lip, however, does not have to connect the left and right vertices of the front face. It may alternatively proceed from an intermediate height on the left face to an intermediate height of the right face.

The canted grill additionally comprises four legs. There is a front and back right leg 262, 263 and a front and back left leg 264, 265. Each leg comprises an upper extension 266, a lower extension 268 and an optional wheel 272. The legs are telescoping legs. The lower extension nests within the upper extension. Each extension has a square cross section, but any cross section may be used. An array of set holes 274 is provided along the length of each lower extension. A hinged clip 276 is provided on each upper extension. Each clip comprises a pin 278 that passes through a hole in the upper extension and engages a set hole in the lower extension. Thus the length of each leg can be adjusted by rotating the clip out to withdraw the pin from a set holes in the lower extension, aligning a different set hole with the pin so that the leg has a desired length, and rotating the clip back in to insert the pin into the desired set hole. The clip may be spring loaded to automatically urge the pin into the desired set hole in the lower extension.

The wheels are provided on the bottoms of the legs to allow the grill to be rolled around. Large diameter wheels, such as 10 cm or larger, may be provided to allow easy rolling over rough terrain. A handle 242 may be provided in the lid to allow a user to push or pull the grill around.

The top of the legs are attached to the base near the left or right vertices using settable pivot joints 282. A pin 284 may be provided to engage a set point in the pivot joints. The set points illustrated in FIG. 2 show the legs in a usage configuration where the legs are generally vertical. This is for rolling the grill around and then using the grill. These are termed the “usage set points”. The usage set points orient the plane of the lip and hence the plane of the cooking grate (item 404, FIG. 4) in a generally horizontal orientation. The usage set points also orient the legs in a downward splay 286 to provide stability for the legs so that the grill does not easily tip over when moved or used on uneven ground.

With the grill in the usage configuration shown in FIG. 2, a deep side 232 of the base is provided on the right side of the grill and a shallow side of the base 234 is provided on the left side of the base. Referring to FIG. 6, a charcoal grate 602 within the base is configured to contain charcoal in a firebox 636 on the deep side of the base. This provides a searing zone on the cooking grate 404 above it. A pan grate 622 in combination with a support grate 624 excludes charcoal from the shallow side of the base to provide a roasting section of the cooking grate 404 above the pan grate.

Referring back to FIG. 2, a top vent 244 is provided near the top vertex of the lid to allow smoke and other combustion products to leave the grill. A bottom vent 248 is provided near the bottom vertex of the base to provide fresh air to the burning charcoal therein.

### BRIEF DESCRIPTION OF DRAWINGS

FIG. 1A is a perspective view of a prior art charcoal grill.

FIG. 1B is a perspective view of the prior art charcoal grill of FIG. 1 with the lid removed.

FIG. 2 is a front left perspective view of a canted grill with the lid closed.

FIG. 3 is a front left perspective view of a canted grill with the legs folded against the front face and back face for storage.

FIG. 4 is a front top left perspective view of a canted grill with the lid open.

FIG. 5 is a front top left perspective view of a canted grill with the left wing of a cooking grate lifted up.

FIG. 6 is a front perspective view of a canted grill with the front face and back face of the base rendered transparent so that the charcoal grate inside the base is visible.

FIG. 7 is a front right top perspective view of the lid of a canted grill showing the top vent open.

FIG. 8 is a front right top perspective view of an exploded view of components of the canted grill of FIG. 2.

FIG. 9A is a front left perspective view of a lid hinge.

FIG. 9B is a right rear perspective view of a lid hinge.

FIG. 10 is an exploded side perspective view of the lid bracket and base bracket of the hinge of FIG. 4.

FIG. 11 is a front top left perspective view of a two wheel canted grill design.

FIG. 12 is a rear top right perspective view of the canted grill of FIG. 11.

FIG. 13 is a close up left perspective view of a pivot joint of the canted grill of FIG. 11.

FIG. 14 is a rear view of the canted grill of FIG. 11 folded into a storage configuration.

FIG. 15A is a side view of a separable lid hinge.

FIG. 15B is a rear view of the separable lid hinge of FIG. 15A.

FIG. 16A is a rear perspective exploded view of the separable lid hinge of FIG. 15A.

FIG. 16B is a rear perspective exploded view of the separable lid hinge of FIG. 15A with an added bumper.

FIG. 17 is a side view cross section of the separable lid hinge of FIG. 15A with the hinge open.

FIG. 18 is a bottom perspective view of the top vent of FIG. 7.

FIG. 19 is a top front right perspective view of a canted grill with a skillet tray.

FIG. 20 is a top front right perspective view of the skillet tray of FIG. 19.

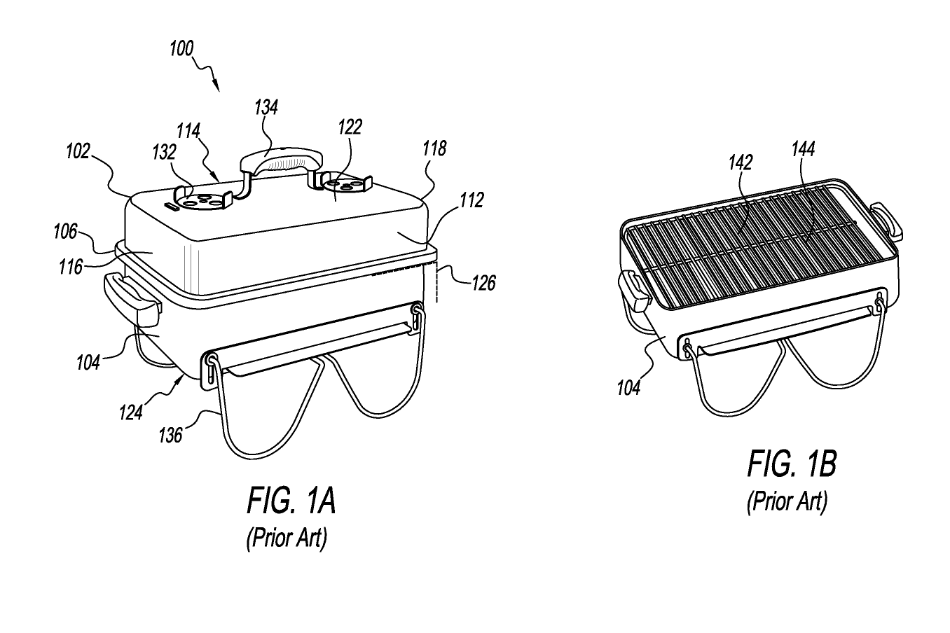

### DETAILED DESCRIPTION

The detailed description describes non-limiting exemplary embodiments. Any individual features may be combined with other features as required by different applications for at least the benefits described herein.

As used herein, the term “about” means plus or minus 10% of a given value unless specifically indicated otherwise. As used herein, the term “generally” means that a described object will appear to have an indicated property to a casual observer although it will not necessarily have the exact property. Thus if two items are “generally parallel”, they will appear parallel to a casual observer, but may not necessarily be mathematically parallel.

As used herein, relative position terms such as “distal”, “proximal”, “top”, “bottom”, “left” and “right” are defined by their initial use for a particular illustration of an object. Once defined by initial use, the relative terms continue to refer to the same portion of an object even if the object is illustrated with another orientation, or unless indicated otherwise. As used herein “right”, “left”, “front” and “back” contemplate the mirror images of the objects described. Thus the statement “the cooking grate is at an acute angle with respect to the right side” also describes a mirror image of the grill where the cooking grate is at an acute angle with respect to the left side. “Right” and “left” may also be used relative to a user's perspective as opposed to from an object's perspective.

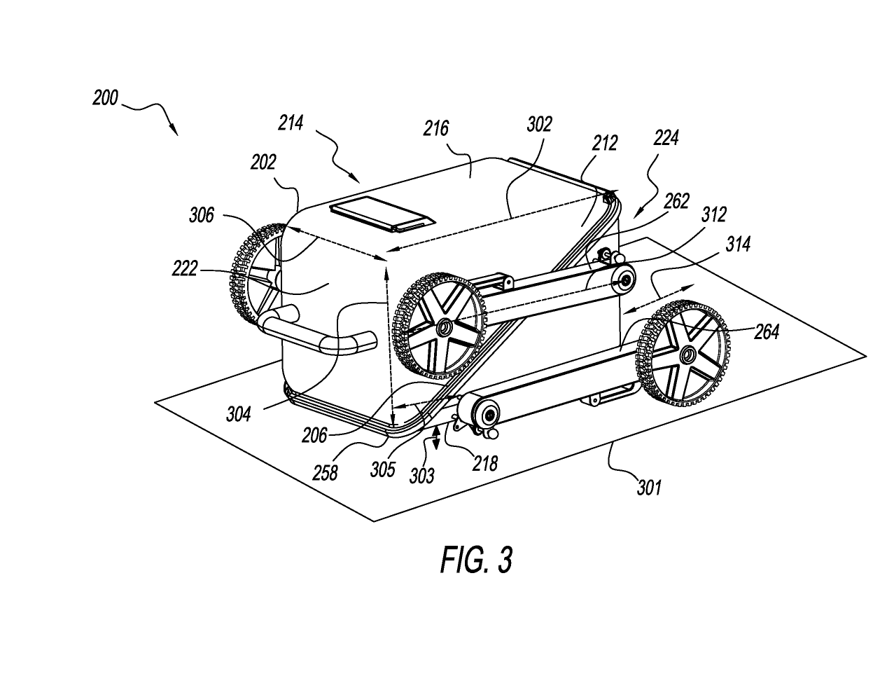

FIG. 3 is a front left perspective view of the canted grill 200 folded into a storage configuration. The lid 202 is closed on the base 204 to form the cooking chamber. The legs have been collapsed and rotated about their pivot joints to rest against the front 212 or back 214 faces of the cooking chamber. This allows the bottom face 218 of the cooking chamber to rest in proximity to a horizontal surface 301. As used herein, “in proximity” means that the standoff 303 of the bottom face from the horizontal surface is less than or equal to 20% of the height 304 of the cooking chamber. The standoff may be due to wheels, lips or other protrusions of the canted grill that suspend the bottom face above the horizontal surface. Storage set points in the pivot joints may be provided to hold the legs in these storage positions. The collapsed length 312 of the legs is less than the width 302 of the cooking chamber. This allows the right legs (e.g. right front leg 262) to rest against the front and rear faces with little or no overhang. The left legs (e.g. left front leg 264), however, do have some overhang 314 since their pivot joints have to be significantly offset 305 from the left face 222. This is due to the shallow angle that the lip 206 makes with respect to the bottom face when the lip intersects the left vertex 258.

The width 302, height 304 and depth 306 of the cooking chamber are selected according to the needs of a particular application. The width separates the left face 222 from the right face 224. The height separates the top face 216 from the bottom face 218. The depth separates the front face 212 from the back face 214. A depth about equal to the height is suitable. A width about equal to 1.5× the height is suitable. A ratio of width to height in the range of 1.2 to 2.3 will provide a significant difference between the depth of the deep side of the base versus the depth of the shallow side of the base. It will also give an adequate width to the shallow side to have a significant area of the cooking grate that is not directly heated by the charcoal for roasting while as the same time have a significant area of the cooking grate exposed to direct heat from the charcoal for searing.

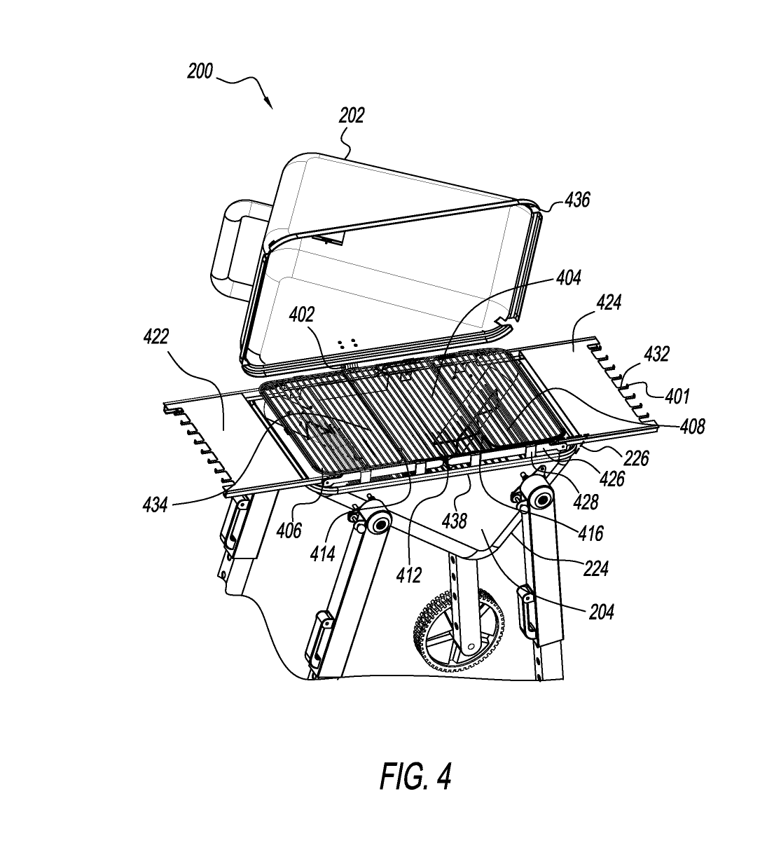

FIG. 4 is a top front left perspective view of the canted grill 200 in an open configuration. The back of the lid 202 is attached to the back of the base 204 with a lid hinge 402. The hinge has a stop at an opening angle of 90 degrees or more so that the lid will remain upright when open. A cooking grate 404 is mounted at about the upper edge of the base. The cooking grill may comprise a left side wing 406, horizontal center portion 412 and right side wing 408. The left and right side wings are attached to the center portion with a left and right grate hinge 414, 416 respectively. This allows the wings to be opened up while the center portion remains horizontal. A drip pan 434 is visible through the cooking grate.

A left side tray 422 and right side tray 424 are mounted on telescoping runners 426 that extend out of the left and right sides of the base. The outer edge of the trays may comprise one or more prongs 432 for hanging cooking utensils. The prongs may have upward bent end tips 401. The telescoping runners are held on the base by one or more clips 428 mounted on the rim 438 of the base. The cooking grate is mounted on the top of the clips. Thus the trays can be slid under the cooking grate and into the cooking chamber for storage when the runners are collapsed.

One or more notches 436 may be provided in the lip of the lid so that the lid can be closed over the runners when said runners are extended and said right or left side tray is outside of said cooking chamber.

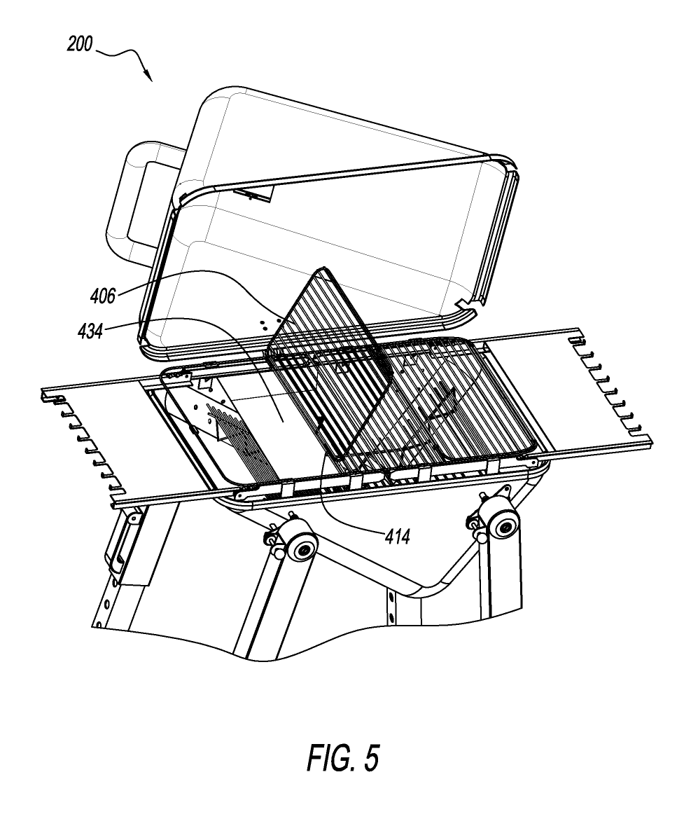

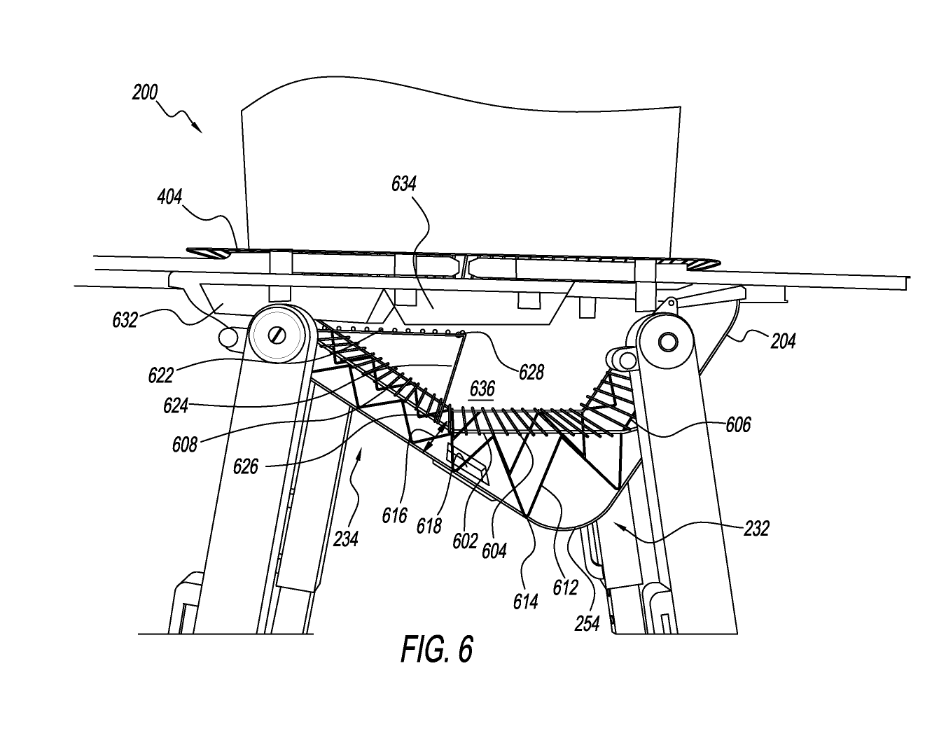

FIG. 5 is a top front left perspective view of the canted grill 200 in an open configuration with the left wing 406 of the cooking grate opened up about the left grate hinge 414 so that a user can add or remove the drip pan 434. The right wing can be similarly opened to allow the user to add charcoal to a firebox on the right side. The firebox will be described in more detail with respect to FIG. 6.

FIG. 6 is a front perspective view of the canted grill 200 in an open configuration and with the front face and rear face of the base 204 rendered transparent. This allows the charcoal grate 602 to be visible therein. The charcoal grate within the base is shaped to form a firebox 636 to hold charcoal on the deep side 232 of the base. The charcoal grate may comprise a horizontal floor 604, a right ascending side 606 and a left ascending side 608. The illustrated ascending sides are parallel to their respective faces of the base. They may alternatively be at a different angle.

The charcoal grate is elevated off of the base with one or more triangular supports 612. The lower vertices 614 of the supports rest on the inside surface of the base providing a standoff 616 between the charcoal grate and the base. The standoff allows ash from burning charcoal to fall down and accumulate in the bottom of the base.

A bottom vent 618 may be provided in the base at a level below the horizontal floor of the charcoal grate but significantly above the bottom vertex 254 of the base. This will provide combustion air to the charcoal resting in the firebox 636 without being unduly blocked by ashes that accumulate in the bottom vertex.

A horizontal pan grate 622 may be on the shallow side of the base 234. The pan grate may extend horizontally from a hinge at about the top of the left ascending side of the charcoal grate. A generally vertical support grate 624 may extend from a hinge 626 at about the bottom of the left ascending side. One or more hooks 628 may be provided at the top of the support grate to engage the distal end of the pan grate. One or more drip pans 632, 634 may rest on the pan grate and below the cooking grate 404. The drip pans may collect drippings from a cut of meat roasting on the left side of the cooking grate. The drip pans may also serve to prevent direct heating of the food placed above them by the burning charcoal in the firebox.

The volume bounded by the support grate, horizontal floor, and right ascending side is referred to as the firebox 636. The firebox may be charged with charcoal by raising the right wing 408 of the cooking grate and pouring charcoal in. The support grate serves to keep the charcoal on the deep side 232 of the base. Alternatively another source of heat, such as a gas burner or electric heater, may be provided in the firebox.

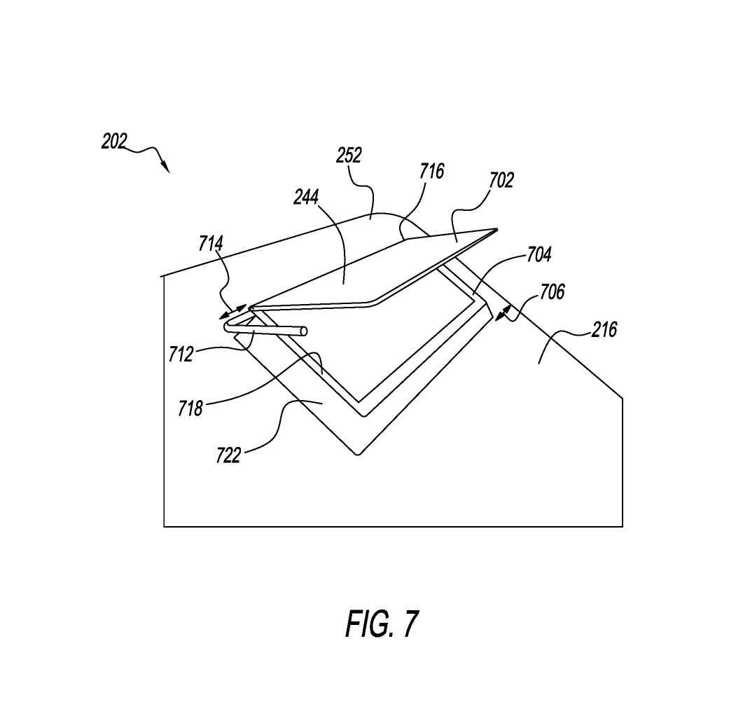

FIG. 7 is a top front right perspective view of the lid 202 of the canted grill showing the details of the top vent 244 mounted on the top face 216 near the top vertex 252. The bottom vent has a similar design. The top vent comprises a flap 702 and collar 704. The collar may comprise an upper flange 718 and a skirt 722. The collar is attached to the lid and provides a standoff 706 for the flap. The flap is attached to the collar with a hinge 716. A side handle 712 extends laterally from the flap by a lateral offset 714 and then bends forward. The flap is attached to the collar by the hinge such that the flap will form a seal with the collar when the side handle is pushed down. The side handle will then be below the upper flange 718 of the collar.

The standoff and the lateral offset of the side handle provide a spacing between the handle and the lid and the handle and the collar when the handle is pushed down so that the handle remains relatively cool. The lateral offset also helps keep the handle cool by keeping it away from the hot exhaust gases coming out of the top vent when the top vent is open.

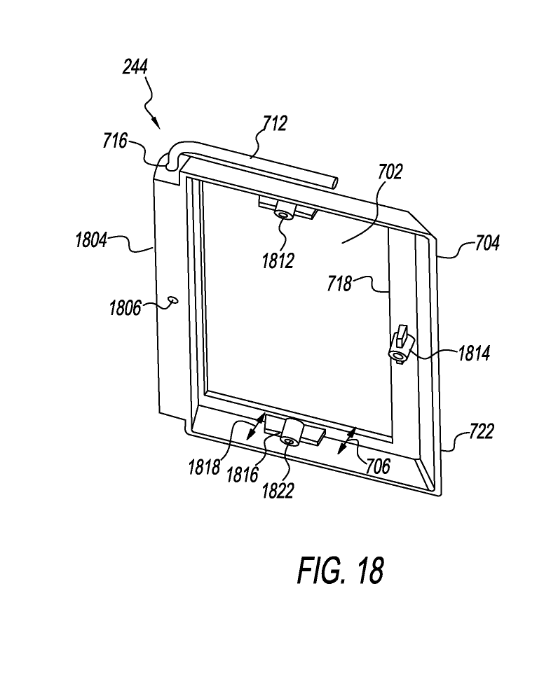

A bottom perspective view of the top vent 244 is presented in FIG. 18. The side handle 712, collar 704 and bottom of the flap 702 can be seen. The collar comprises the upper flange 718, the skirt 722, and a lower flange 1804. The upper flange provides a platform for the flap to seal against when closed. The lower flange provides room for the hinge 716. The lower flange of the collar rests directly on the top face of the lid. It may be joined thereto by a screw or other fastener. A mounting hole 1806 may be provided in the lower flange.

One or more studs 1812, 1814 and 1816 may be attached to the bottom side of the upper flange of the collar. The height 1818 of the studs may be about equal to the standoff 706 of the collar so that the studs span the gap between the bottom side of the upper flange and the top surface of the top face of the lid. Thus fasteners, such as screws, may proceed up through the top face of the lid and into the studs to hold the collar in place. A vertical hole 1822 may be provided in each stud to accommodate a screw.

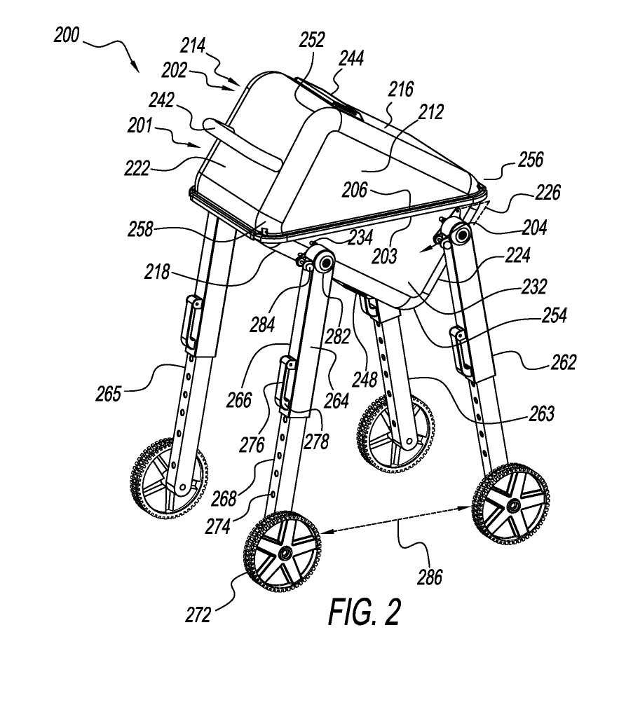

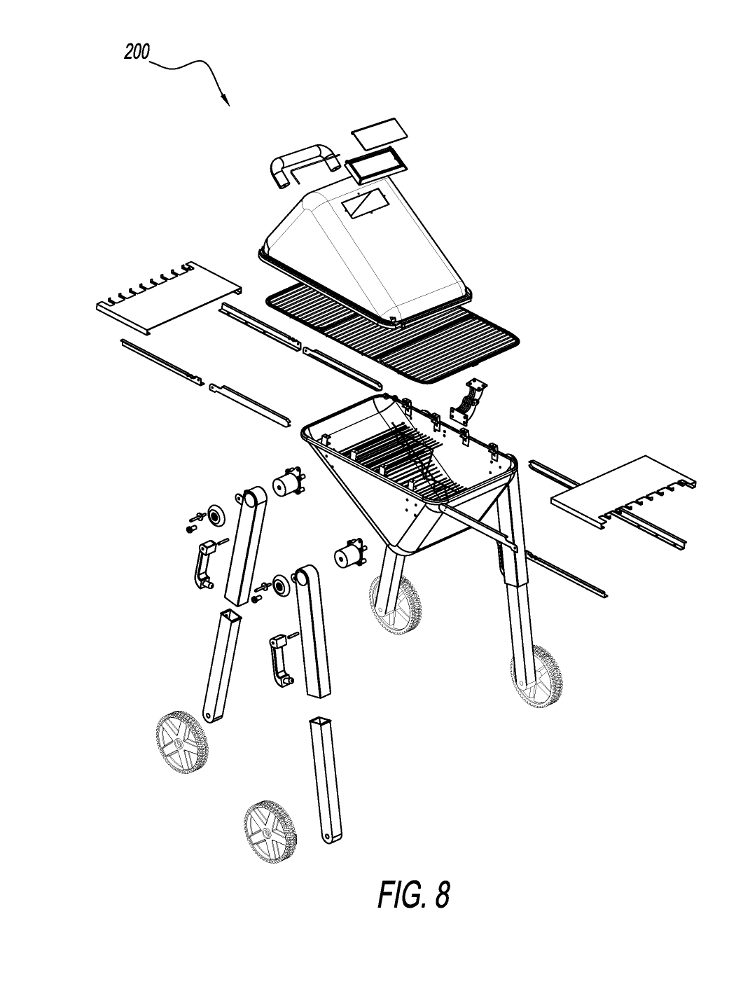

FIG. 8 is a top front right perspective exploded view of the canted grill 200 in the usage configuration of FIG. 2 showing the individual components as described herein. Reference may be made to the description and figures above to identify the individual components.

### Lid Hinge

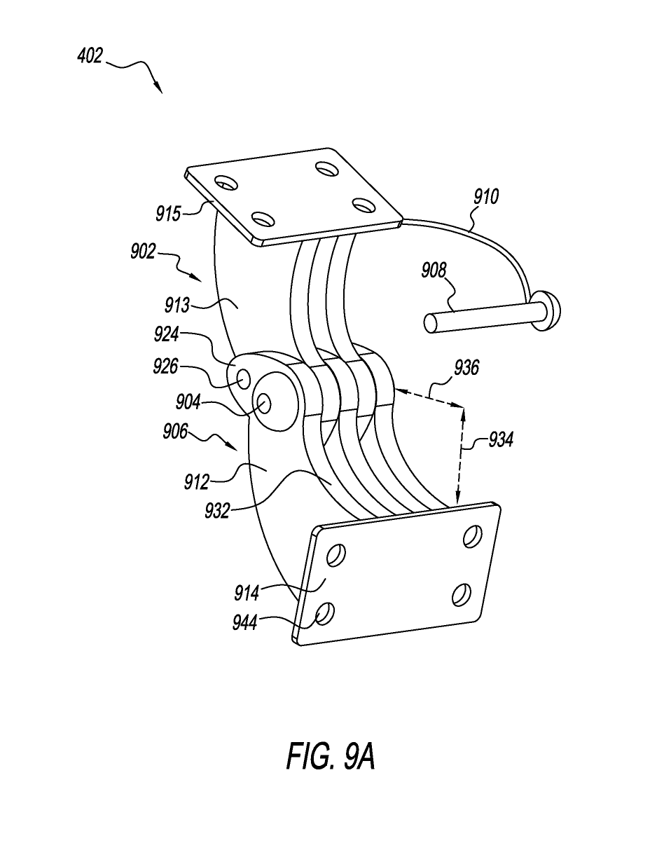

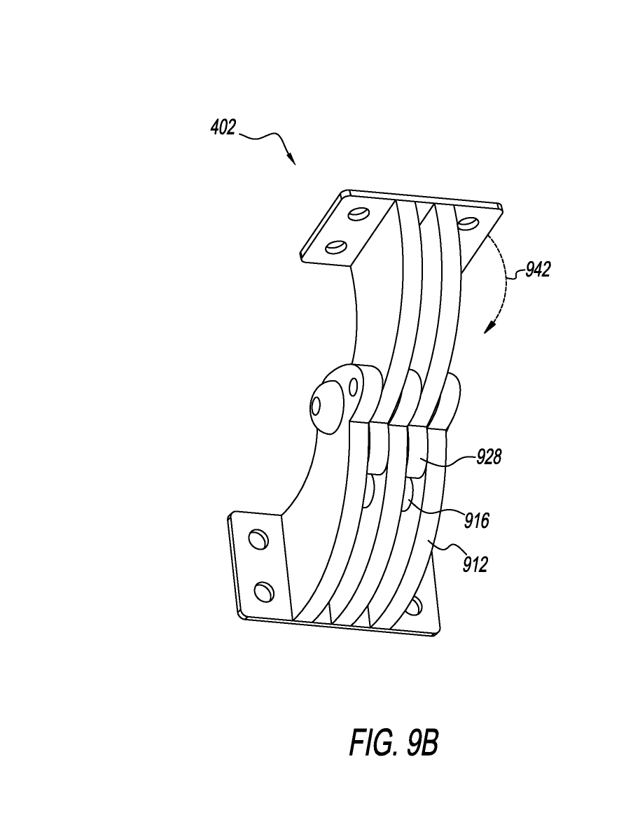

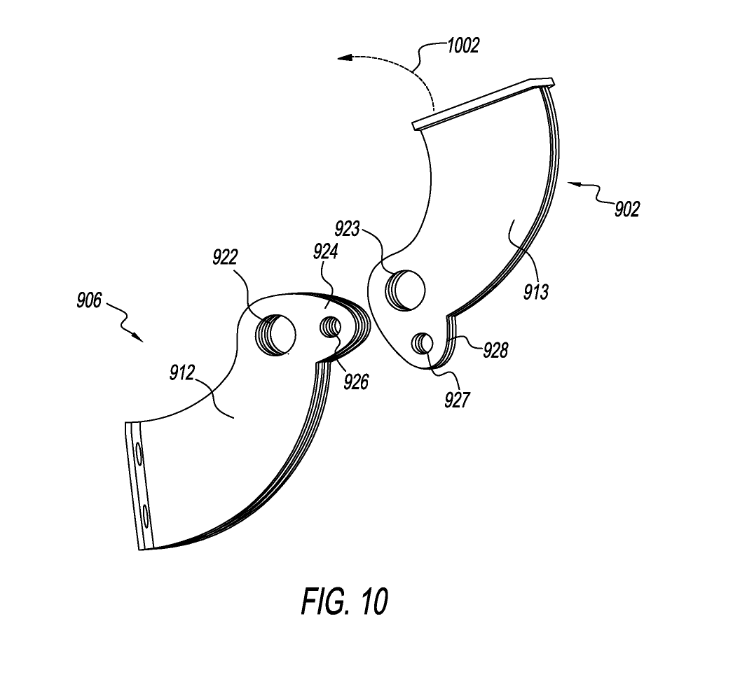

FIG. 9A is a front left perspective view of the lid hinge 402 of FIG. 4. FIG. 9B is a rear right perspective view of the lid hinge 402. FIG. 10 is an exploded side perspective view of the lid bracket 902 and base bracket 906 of the lid hinge 402.

Referring to FIG. 9A, the lid hinge 402 comprises a lid bracket 902, a pivot pin 904, a base bracket 906, and a tab pin 908. Each bracket comprises one or more lateral leaves 912, 913 extending at right angles from a flange 914, 915. Each leaf comprises a pivot hole 922, 923 (FIG. 10) and a tab 924, 928 (FIG. 10) at its distal end. When the hinge is assembled, the pivot holes are aligned and the pivot pin passes therethrough. The pivot pin may be a rivet with rounded ends.

Referring to FIG. 9B, one or more spacers 916 may be provided between the lateral leaves 912 of the base to set the spacing between said lateral leaves. The lid tabs 928 are dimensioned to contact the spacers when the lid of the grill is opened so that said spacers will serve as a stop to arrest the rotary motion 942 of the lid. Thus the lid will have a stable open configuration as shown in FIG. 4.

Referring to FIG. 10, the tabs are further dimensioned so that the tab holes 926 in the base tabs and the tab holes 927 in the lid tabs will align when the lid is rotated closed 1002. The tab pin can then be inserted through the tab holes to keep the lid from opening after it has been closed. The tab pin may be attached to a flexible leash 910 (FIG. 9A) which in turn is attached to a portion of the grill. This will keep the tab pin from getting lost when it is removed from the tab holes to open the grill.

Referring back to FIG. 9A, the inside edge 932 of each leaf extends backward and inward to create a space for the lip 206 (FIG. 2) of the grill. The height 934 and depth 936 of the inside edge are selected so that the axis of the pivot pin will be in about the plane of the lip. The actual curvature or other shape of the inside edge can be selected for aesthetic purposes provided there is sufficient clearance for the lip of the lid.

One or more flange holes 944 can be provided in the flanges for mounting them to the back face 214 (FIG. 2) of the lid and base.

The hinge can be made of any suitably strong material, such as steel. The material may be coated for aesthetic purposes or corrosion protection. Any hinge design with clearance for the lip may be used. An advantage of the disclosed design is that it has large side-to-side stiffness so that only a single hinge is required.

The grill itself can be made of any suitable combination of materials, such as coated steel for the lid and base, stainless steel for the grates, aluminum for the legs and plastic for the wheels.

### Two Wheel Canted Grill

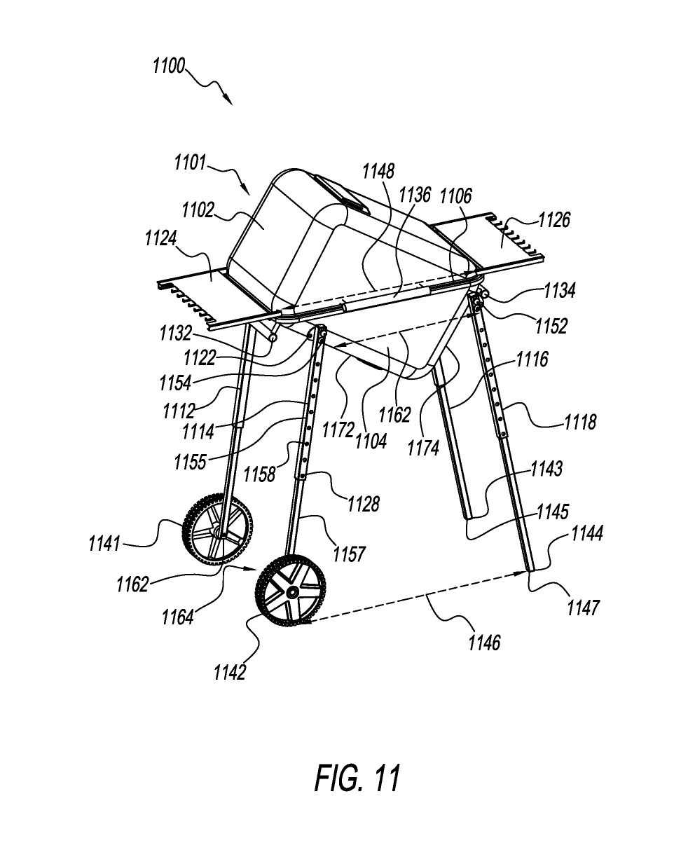

FIG. 11 is a top front left perspective view of an alternative two wheel design 1100 of a canted grill. The canted grill is in a usage configuration. The two wheel canted grill comprises a lid 1102, base 1104, rear left leg 1112, front left leg 1114, rear right leg 1116 and front right leg 1118. The lid and base form a cooking chamber 1101. The left legs each have a wheel 1141, 1142 on their bottom ends 1160, 1164. The right legs have straight bottom ends 1143, 1144. End caps 1145, 1147 may be provided at the straight bottom ends to reduce the penetration of the right legs into soft ground.

The lid and base of the two wheel canted grill are similar to the lid and base of the four wheel canted grill of FIG. 2. The two wheel canted grill also has a left side tray 1124 and right side tray 1126 similar to the four wheel design. The internal structure, such as the charcoal grate and cooking grates are also similar.

The two wheel canted grill has a left handle 1132 on the left side of the base just below the lip 1106 of the lid. It also has a right handle 1134 on the right side of the base just below the lip of the lid. A front handle 1136 is provided on the front of the lid just above the lip of the lid. The left and right handles are used for wheeling the canted grill around. The front handle is used to open and close the lid.

Each leg comprises an upper extension 1155 and a lower extension 1157. The lower extension nests within the upper extension. An array of set holes 1158 is provided in the upper extensions. A snap button 1128 is provided in the lower extensions. A snap button proceeds out through a set hole in an upper extension of a leg to set the length of a leg. A user may adjust a length of a leg by pushing the snap button in and sliding the lower extension within the upper extension until the snap button engages a desired set hole.

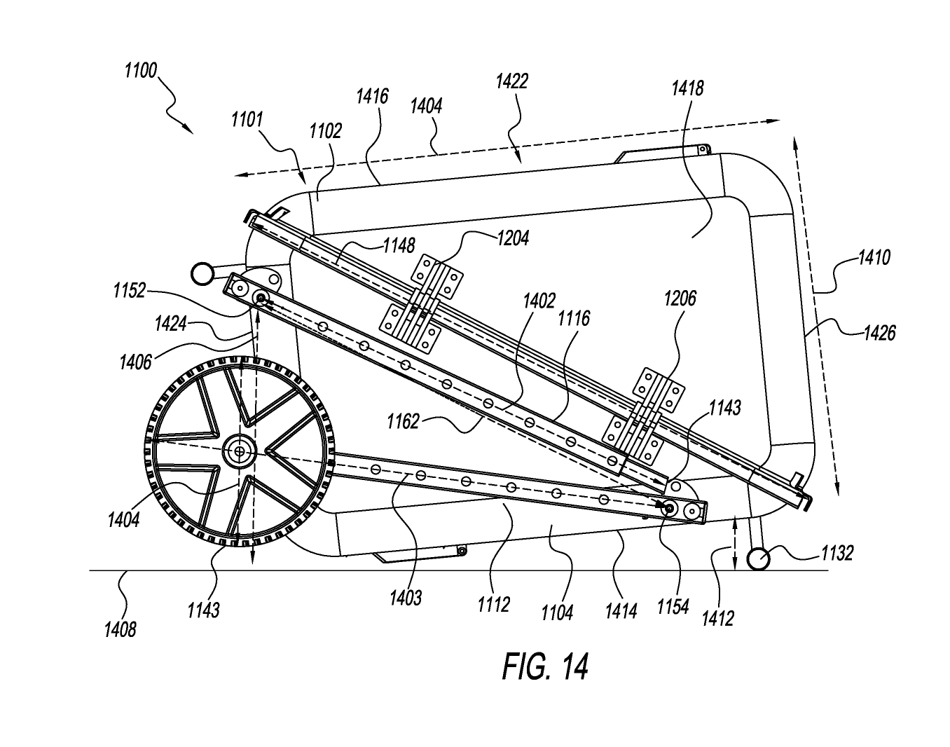

Each upper extension is pivotably attached to the base at a pivot joint 1122. The pivot joint has at least two set points. A first set point corresponds to the leg being in a usage configuration such as that shown in FIG. 11. A second set point corresponds to the leg being in a storage configuration. The storage configuration will be described in more detail with respect to FIG. 14. Additional set points may be provided as needed. For example, set points may be provided to hold the front legs in an extended but swept back orientation for easier wheeling of the canted grill.

The tops of the left legs are attached to a left pivot axle 1154. The left pivot axle proceeds from the front of the base, through the base, to the back of the base. The tops of the right legs are attached to a right pivot axle 1152. The right pivot axle similarly proceeds from the front of the base to the back of the base. Internal bracing may be provided in the base to hold the axles. This will allow relatively thin gauge material to be used for the base.

The pivot axles may alternatively be lateral studs that proceed from the front and back of the base and do not go through the base.

The left legs with the wheels are attached to the shallow side 1172 of the base. This will allow for room for the wheels at the bottom of the legs to move to the deep side 1174 of the base when the legs are collapsed and rotated into a storage configuration. This will be discussed in more detail with respect to FIG. 14.

The pivot axles of the left and right legs may be separated by a pivot axle spacing 1162. This should be as large as possible for the dimensions of the base. There may be a downward opening splay 1146 in the legs. The splay may be about the same as the lip width 1148 of the lid. This will help insure stability of the canted grill when it is set up. The splay may be larger than the lip width so that the bottoms of the legs are underneath the left and right side trays when they are extended.

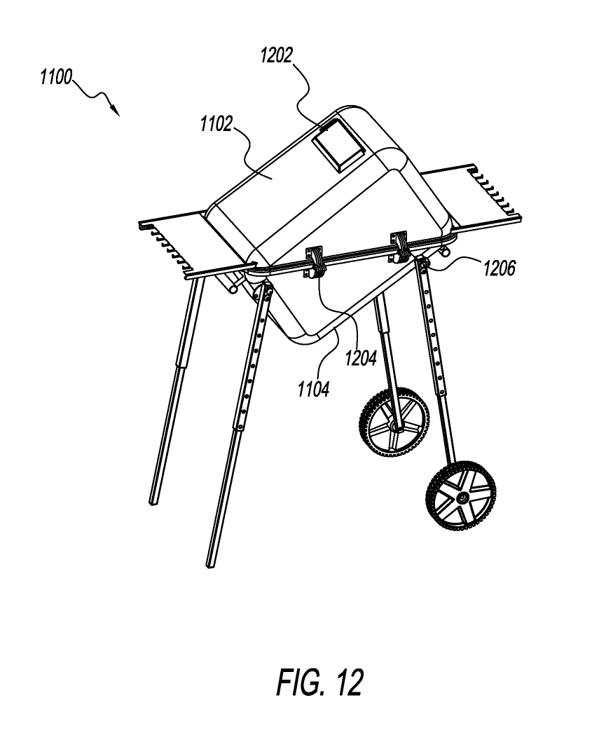

FIG. 12 shows a rear top right perspective view of the two wheel canted grill 1100. A left lid hinge 1206 and right lid hinge 1204 may be provided to pivotably attach the lid 1102 to the base 1104. A top vent 1202 is visible.

### Pivot Joint

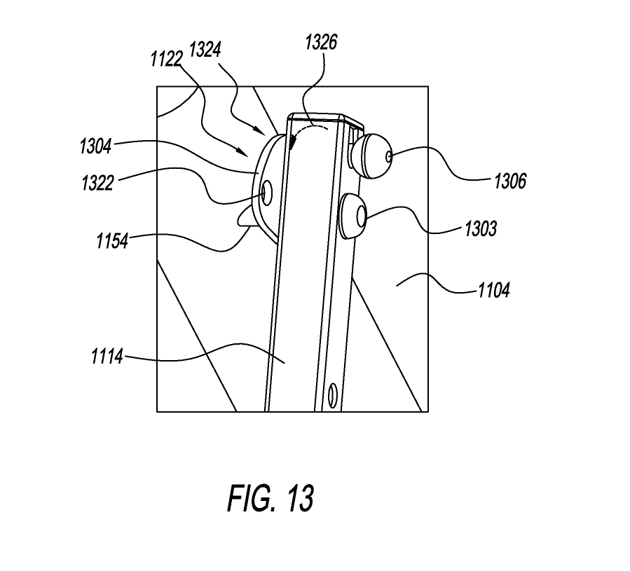

FIG. 13 is a front left perspective view of the pivot joint 1122 of FIG. 11. The pivot joint is for the front left leg 1114. The pivot joints for the other legs are similarly designed. The pivot joint comprises a pivot axle 1154, a back plate 1304 and a spring loaded pull pin 1306. The back plate comprises a storage set hole 1322 and a usage set hole 1324. The usage set hole is behind the top of the front left leg in the illustrated usage configuration. The pull pin proceeds through the leg and is engaging the usage set hole so that the leg is locked in the usage configuration.

The back plate is mounted on the pivot axle at right angles to the pivot axle. The pivot axle is rigidly mounted to the base 1104 so that the back plate does not rotate when the leg is rotated. A pivot axle cap 1303 may be provided at the end of the pivot axle to hold the leg against the back plate. Adequate clearance should be provided to allow the leg to rotate freely about the pivot axle when the pull pin is pulled out.

To change from a usage configuration to a storage configuration, the pull pin is pulled out. This disengages the pull pin from the usage set hole. The leg is rotated 1326 until the pull pin aligns with the storage set hole. The user then releases the pull pin and it engages the storage set hole. This holds the leg in a storage configuration. Other mechanisms, such as clips, may be used to secure the legs in either the usage configuration or storage configuration.

### Storage Configuration

FIG. 14 is a rear view of the two wheel canted grill 1100 in a storage configuration. The lid 1102 fits on the base 1104 to form the cooking chamber 1101. The left face 1426, right face 1424, top face 1416, bottom face 1414 and back face 1418 are all visible. The front face 1422 is behind the back face. The bottom face is resting in proximity to a horizontal surface 1408. The left handle 1132 tips the base up slightly. The ratio of the standoff 1412 of the bottom face to the height 1410 of the cooking chamber is about 0.16.

The right legs (e.g. item 1116) and left legs (e.g. item 1112) have been collapsed to their shortest lengths. The legs have also been rotated into their storage positions resting against the front and back faces. The collapsed length 1403 of the left leg is defined as the distance from the left leg pivot axle 1154 to the bottom of the wheel 1143. The collapsed length 1402 of the right leg is defined as the distance from the right leg pivot axle 1152 to the bottom end of the leg 1143. The collapsed lengths of the legs may be less than the width 1148 of the lip. They may also be less than the width 1404 of the cooking chamber. This will minimize the overhang of the ends of the collapsed legs past the right or left faces when the legs are in their storage position.

The storage position of the right rear leg is adjacent to the right 1204 and left 1206 lid hinges. In order to the reach this position, the collapsed right leg length 1402 must be less than the pivot axle spacing 1162 so that the bottom of the right leg will clear the top of the left leg as the right leg is rotated into position. Similar design considerations apply to the front legs.

The storage position of the left leg 1112 is high enough so that the rear wheel 1141 sits at or above the horizontal surface without hitting the right leg 1116. The diameter 1404 of the wheel may be less than the height 1410 of the cooking chamber. The diameter of the wheel may also be less than the elevation 1406 of the right leg pivot axle 1152 above the horizontal surface 1408. The diameter of the wheel should, however, be as large as possible so that the grill can be rolled around easily, especially on rough or soft ground (e.g. sand). A suitable diameter of the wheel is in the range of 0.25 to 0.75 times the height 1410 of the cooking chamber. Similar design considerations apply to the front legs. Thus the two wheel canted grill forms a very compact storage configuration.

### Separable Lid Hinge

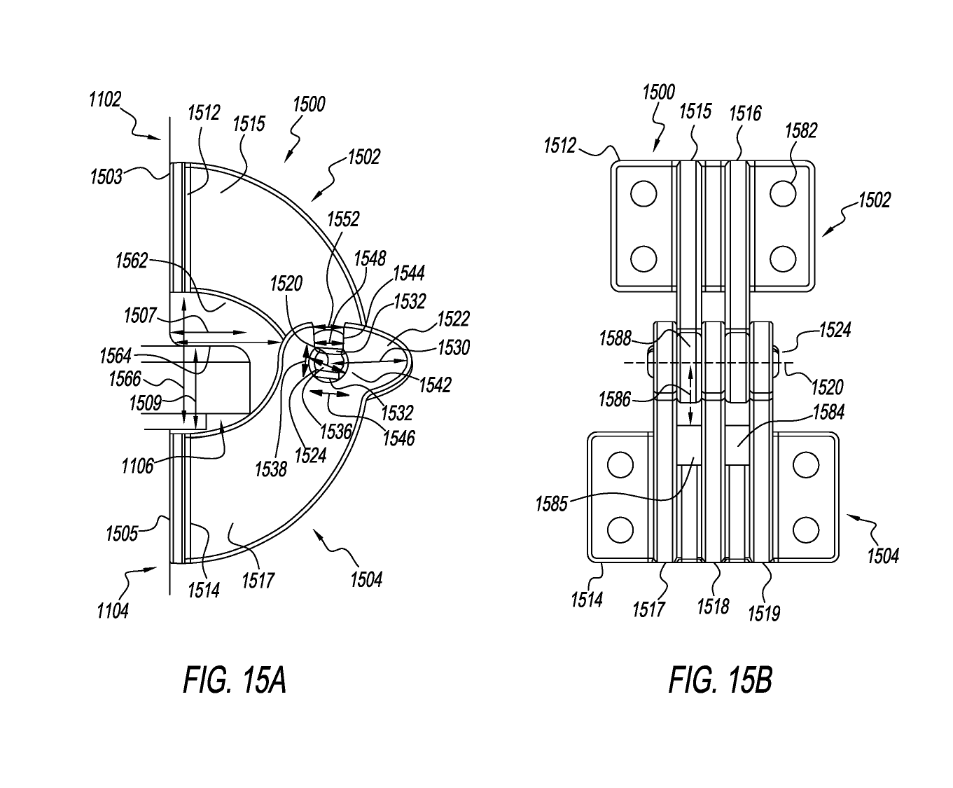

FIG. 15A shows a right side view of a separable lid hinge 1500. This is the same hinge design shown for the left and right lid hinges in FIG. 14. All lid hinge designs disclosed herein may be used for any grill with a lid with a lip. The separable lid hinge comprises a lid bracket 1502 hingedly joined to a base bracket 1504. The lid bracket comprises a vertical flange 1512 and one or more lateral leaves 1515. The base bracket similarly comprises a vertical flange 1514 and one or more lateral leaves 1517. The vertical flange of the lid bracket is shown mounted on the back face 1503 of the lid 1102 of the two wheel canted grill. The vertical flange of the base bracket is shown mounted on the back face 1505 of the base 1104 of the two wheel canted grill.

The lid bracket additionally comprises a transverse pivot pin 1524. The pivot pin is rigidly mounted to the lateral leaves of the lid bracket. The pivot pin has a generally round cross section with a pin diameter 1536. The pin is modified from a round cross section by two opposite parallel flat surfaces 1532. These surfaces are referred to herein as “flats”. The flats are separated by a flat spacing 1538. The flat spacing is less than the pin diameter.

The distal end of each lateral leaf of the base bracket comprises a generally round pin opening 1542. Each pin opening is described by a pin opening diameter 1546. The distal end of each lateral leaf of the base bracket further comprises a keyhole slot 1544. The keyhole slot provides a channel connecting the pin opening to the outside of the lateral leaves of the base bracket. The keyhole slot may be flared from an inside width 1548 to an outside width 1552. The inside width must be at least as large as the flat spacing.

In operation, the pivot pin is rotatably located within the pin openings as the hinge rotates. Once the flats of the pivot pin align with the keyhole slot, however, the pin may proceed through the keyhole slot so that the lid bracket and base bracket can be separated. This allows the user to easily separate the lid from the base. This, in turn, allows the lid and base to nest together for shipping, and then subsequently assembled for use without the need for tools.

The lateral leaves of the lid bracket and base bracket are arched towards each other to form a hinge throat 1562 therebetween. The hinge throat may be described by a height 1566 and lateral extension 1564. The lip 1106 of the lid may also be described by a height 1509 and a lateral extension 1507. The height and lateral extension of the hinge throat should each be greater than the respective height and lateral extension of the lip. The specific shape of the hinge throat may be set by aesthetic considerations as long as the hinge throat does not hit the lip.

The shape of the vertical flanges of the separable lid hinges should conform to the shape of the lid and base in the intended areas of mounting. The flanges can be flat, curved, or angled as needed. They can be attached to the lid and base by any suitable means, such as screws, rivets, welding or adhesives.

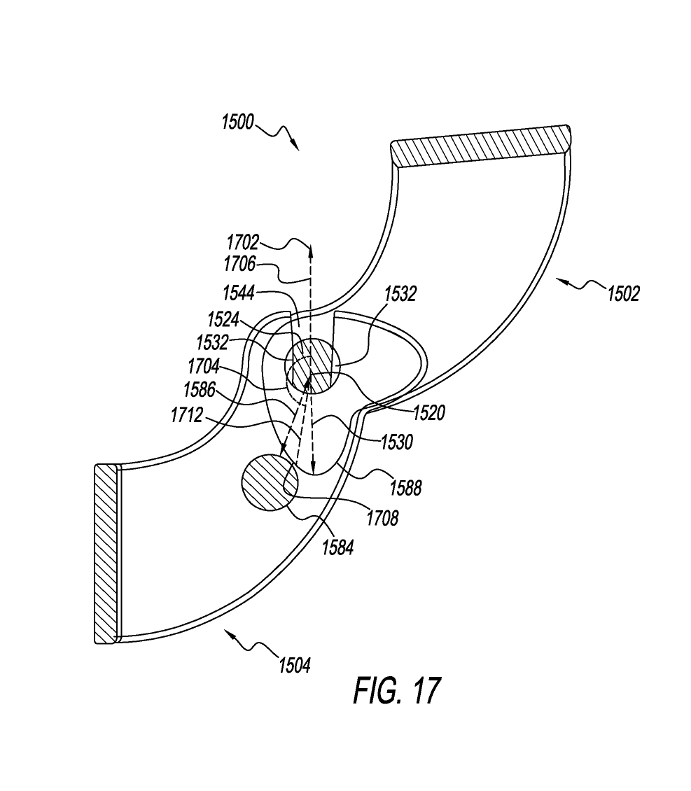

One or more of the lateral leaves of the lid bracket and base bracket may comprise a lateral tab 1522. The tab may be described by a lateral extension 1530. The lateral extension of the tab is measured from the axis 1520 of the pivot pin to the maximum lateral extension of the tab. If one of the lateral leaves of the lid bracket has a lateral tab, it will act as a stop for the rotation of the hinge as described with reference to FIG. 17.

FIG. 15B is a back view of the separable lid hinge 1500. The vertical flanges 1512 and 1514 can be seen. Each vertical flange may comprise one or more mounting holes 1582. These will facilitate mounting on the lid and base using screws or rivets. The lid bracket 1502 comprises two lateral leaves 1515, 1516. The base bracket 1504 comprises three lateral leaves 1517, 1518 and 1519. The lateral leaves of the lid bracket interleave with the lateral leaves of the base bracket. The pivot pin 1524 extends through the lateral leaves of the base bracket. The lid bracket could alternatively comprise one lateral leaf and the base bracket could alternatively comprise two lateral leaves or even one lateral leaf. The separable lid hinge could also be used upside down with the vertical flange of the lid bracket attached to the base and the vertical flange of the base bracket attached to the lid.

Spacers 1584 and 1585 are provided between the lateral leaves of the base bracket. The spacers are positioned with their closest surface to the hinge axis 1520 at a desired radial distance 1586 from said hinge axis. The spacers are also at a desired angular position relative to the centerline of the keyhole slot. The radial distance is less than the tab lateral extension so that the spacer will contact and stop at least one lateral tab (e.g. item 1588) from proceeding beyond it when the hinge is opened. This will be described in more detail with reference to FIG. 17.

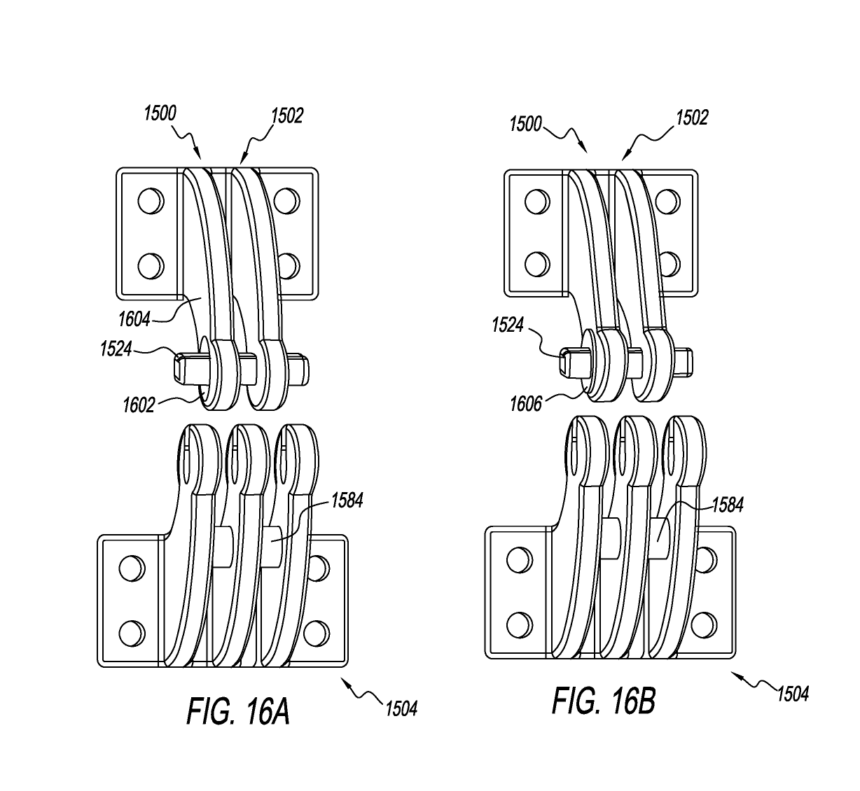

FIG. 16A shows an exploded rear perspective view of the separable lid hinge 1500. The lid bracket 1502, base bracket 1504, pivot pit 1524 and spacer 1584 can be seen. A recess 1602 is provided in the outer surface 1604 of at least one lateral leaf of the lid bracket. The recess is provided around the pivot pin. The recess may be filled with a bumper 1606 (FIG. 16B). The bumper may be an elastomer, such as silicon rubber. The bumper should extend slightly outside of the vertical leaf so that it has to be compressed when the hinge is assembled. This provides a frictional surface so that the opening and closing of the grill is smoother and the grill won't slam shut if it is let go before it is fully open. The bumper also reduces any rattle in the canted grill when it is in a storage configuration and transported.

FIG. 16B shows an exploded rear perspective view of the separable lid hinge 1500 with the bumper 1606 shown as described above. Bumpers may be provided on both lateral leaves of the lid bracket.

FIG. 17 is a side view cross section of the separable lid hinge 1500 in an open configuration. The lid bracket 1502 and base bracket 1504 can be seen. The lateral tab 1588 of a lateral leaf of the lid bracket has contacted the spacer 1584 at a contact point 1708. The contact orientation is determined by the tab lateral extension 1530, spacer radial depth 1586, angular position 1704 of the spacer and the specific shape of the lateral tab and spacer. The angular position of the spacer may be defined as the angle between the centerline 1706 of the keyhole slot and a contact line 1712 connecting the hinge axis 1520 to the contact point 1708 between the lateral tab and spacer. The angular position may also be defined with respect to any convenient geometry of the lid bracket and base bracket. In this embodiment, the contact orientation is for the open configuration of the lid. It is also the orientation that will allow the flats 1532 of the pivot pit 1524 to align with the keyhole slot 1544 so that the lid can be removed 1702 from the base.

### Skillet Tray

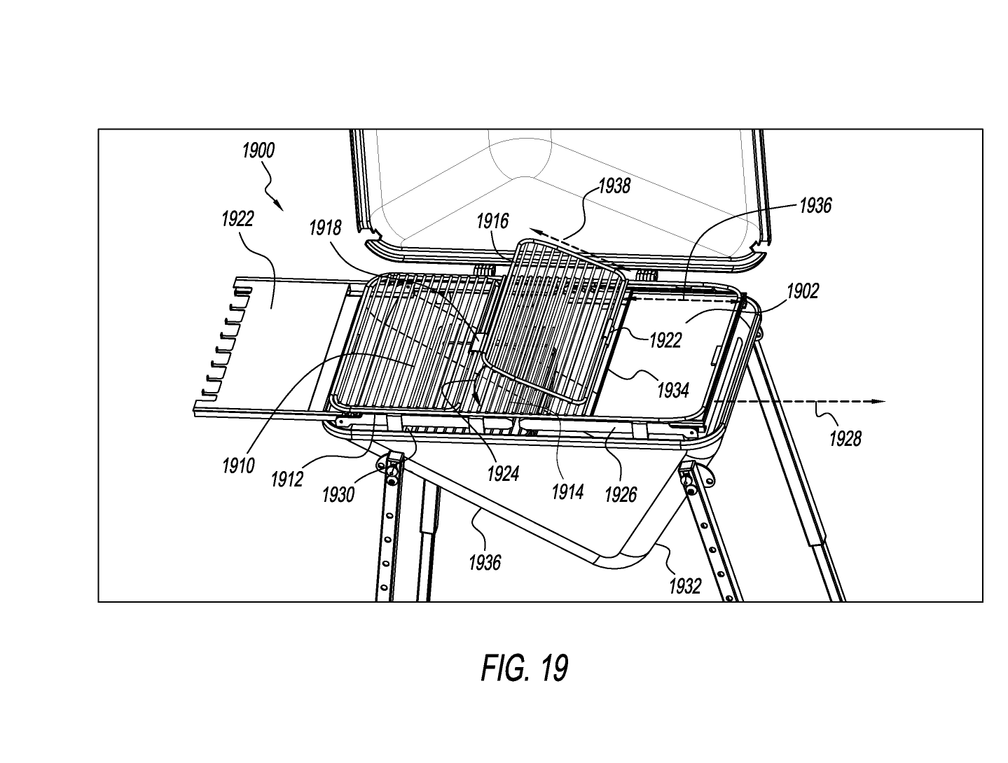

FIG. 19 is a top front right perspective view of canted grill 1900 where the right side tray is a skillet tray 1902. The canted grill 1900 has a cooking grate 1910. The cooking grate comprises a left wing 1912, horizontal center portion 1914 and right wing 1916. The left wing is joined to the center portion by a left grate hinge 1918. The right wing is joined to the center portion with a right grate hinge 1922. The left and right grate hinges are adapted to allow the left and right wings to pivot 180 degrees (e. g. item 1924) so that one or the other can rest on the horizontal center portion. The left side tray 1922 is the same as the design as the left side tray 422 of FIG. 4. It is mounted on a left telescoping runner 1930 so that it can be extended out from under the left wing of the cooking grate and serve as a shelf when the grill is in use. It can then be retracted back underneath the left wing of the cooking grate for storage.

The right skillet tray 1902 is mounted on a right telescoping runner 1926 and may be retracted underneath the right side of the cooking chamber for cooking or extended out 1928 from under the right side to serve as a shelf. When the skillet tray is retracted for cooking, the right wing of the cooking grate is pivoted out of the way 1924 and rests on the horizontal center portion of the cooking grate.

The skillet tray is adapted to withstand the heat from the charcoal in the deep side 1932 of the cooking chamber when the grill is lit. The skillet tray may be made of materials suitable for high heat and food contact. Said materials include stainless steel, copper, cast iron and aluminum. A non-stick coating such as a fluoropolymer, ceramic, or gold plating may be provided on the skillet. A vertical lip 1934 may be provided around the periphery of the skillet to keep grease from flowing off the skillet and into the charcoal below. The lip may also provide additional stiffness to resist warping of the skillet due to heating. A drain (not shown) may be provided in the skillet to capture grease.

The width 1936 of the skillet may be about the same as the width 1938 of the right wing. The skillet may be removable from the telescoping runner so that it can be washed. A right side tray 424 (FIG. 4) may be provided to be interchanged with the skillet. A left skillet tray of similar design to the right skillet tray may be provided for lower temperature skillet cooking on the shallow side 1936 of the canted grill.

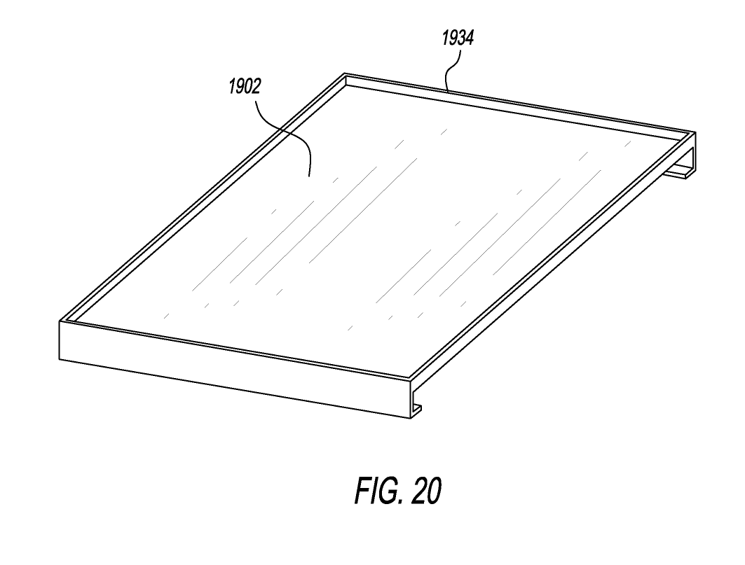

FIG. 20 is a top front right perspective view of the skillet tray 1902. The vertical lip 1934 can be seen around the periphery. Additional features may be provided in the skillet for specialized cooking, such as undulations for searing.

### CONCLUSION

While the disclosure has been described with reference to one or more different exemplary embodiments, it will be understood by those skilled in the art that various changes may be made and equivalents may be substituted for elements thereof without departing from the scope of the disclosure. In addition, many modifications may be made to adapt to a particular situation without departing from the essential scope or teachings thereof. Therefore, it is intended that the disclosure not be limited to the particular embodiment disclosed as the best mode contemplated for carrying out this invention.

We claim:

1. A canted grill comprising:
a) a lid comprising a bottom edge;
b) a base; and
c) a cooking grate
wherein:
d) said lid fits on said base to form a cooking chamber with a generally rectangular box shape comprising:
i) a front face and a back face separated by a depth;
ii) a top face and a bottom face separated by a height; and
iii) a left face and a right face separated by a width;
e) said right face is at about a 90 degree angle with respect to said bottom face; and
f) said cooking grate is mounted within said cooking chamber such that:
i) said cooking grate forms an acute angle with respect to said right face; and
ii) said base has a deep side and a shallow side when said cooking grate is about horizontal.

2. The canted grill of claim 1 wherein the ratio of said width to said height is in the range of 1.2 to 2.3.

3. The canted grill of claim 1 which further comprises a charcoal grate in said base wherein said charcoal grate is shaped to form a firebox to hold charcoal in said deep side of said base.

4. The canted grill of claim 3 which further comprises:
a) a horizontal pan grate in said shallow side of said base; and
b) a drip pan resting on said horizontal pan grate and below said cooking grate such that said drip pan prevents direct heating of food placed above it by charcoal burning in said firebox.

5. The canted grill of claim 1 that further comprises:
a) a front left leg;
b) a back left leg;
c) a front right leg; and
d) a back right leg
wherein said legs are each attached to said base with a pivot joint such that said legs can be set to:
e) a usage configuration wherein said legs are generally vertical and said cooking grate is held at about a horizontal orientation; and
f) a storage configuration wherein said legs fold against said front and back faces of said cooking chamber such that said bottom of said base can rest in proximity to a horizontal surface.

6. The canted grill of claim 5 wherein:
a) each of said legs is a telescoping leg with a collapsed length; and
b) the collapsed length of each leg is less than the width of the cooking chamber.

7. The canted grill of claim 6 wherein:
a) the pivot joints of said left legs are joined by a left leg pivot axle;
b) the pivot joints of said right legs are joined by a right leg pivot axle;
c) said pivot axles are separated by a pivot axle spacing; and
d) said collapsed length of said right legs is less than said pivot axle spacing.

8. The canted grill of claim 7 wherein:
a) each of said left legs comprises a bottom end and a wheel mounted on said bottom end;
b) each of said wheels comprises a wheel diameter; and
c) said wheel diameter is in the range of 0.25 to 0.75 times said height of said cooking chamber.

9. The canted grill of claim 1 which further comprises a lid hinge connecting said lid to said base wherein:
a) said lid hinge comprises:
i) a lid bracket comprising:
1) a vertical flange; and
2) a lateral leaf extending from said vertical flange, said lateral leaf comprising:
a) transverse pivot pin comprising a hinge axis; and
b) a lateral tab extending a lateral extension from said hinge axis; and
ii) a base bracket comprising:
1) a vertical flange;
2) a lateral leaf extending from said vertical flange, said lateral leaf comprising:
a) a pin opening; and
b) a spacer;
b) said pin is rotatably located within said pin opening; and
c) said spacer is located at a radial depth from said hinge axis such that said lateral tab of said lateral leaf of said lid bracket will contact said spacer when said lid bracket is rotated about said hinge axis.

10. The canted grill of claim 9 wherein:
a) said lateral leaf of said base bracket comprises a keyhole slot forming a channel connecting said pin opening to the outside of said lateral leaf of said base bracket;
b) said keyhole slot comprises an inside width;
c) said pin has a generally round cross section comprising opposite parallel flat surfaces separated by a flat spacing;
d) said flat spacing is less than said inside width of said keyhole slot; and
e) said stop is positioned on said lateral leaf of said base bracket such that when said tab of said lateral leaf of said lid bracket contacts said spacer, said flat surfaces of said pin align with said keyhole slot such that said lid bracket can be removed from said base bracket.

11. The canted grill of claim 9 wherein said vertical flange of said lid bracket is attached to said base of said canted grill and said vertical flange of said base bracket is attached to said lid of said canted grill.

12. The canted grill of claim 1 which further comprises a side tray mounted on a telescoping runner wherein:
a) said lid comprises a lip on said bottom edge;
b) said side tray is dimensioned to fit inside said cooking chamber when said runner is collapsed;
c) said runner is dimensioned to position said side tray outside of said cooking chamber when said runner is extended; and
d) said lip comprises a notch dimensioned to fit around said runner when said runner is extended such that said lid can close on said base when said side tray is positioned outside of said cooking chamber.

13. The canted grill of claim 12 wherein said side tray is a skillet tray comprising a vertical peripheral lip.

14. The canted grill of claim 1 wherein:
a) said cooking grate comprises a horizontal center portion and a side wing; and
b) said side wing is attached to said center portion with a grate hinge such that said side portion can be opened up while said center portion remains horizontal.

15. The canted grill of claim 1 wherein:
a) said lid comprises a top vent;
b) said top vent comprises:
i) a flap;
ii) a collar comprising an upper flange and a skirt;
iii) a hinge; and
iv) a side handle comprising a lateral offset; and
c) said flap is attached to said collar by said hinge such that when said handle is pushed down:
i) said flap will form a seal with said collar;
ii) said handle will be below said upper flange; and
iii) there will be a spacing between the handle and the lid and a spacing between the handle and the collar.
